(19) United States
(12) Patent Application Publication
(10) Pub. No.: US 2026/0309292 A1
(43) Pub. Date: Oct. 8, 2026

(54) CHROMATIC EFFECT DAYLIGHT MANAGEMENT UNIT

(71) Applicant: CoeLux S.r.l., Lomazzo (CO) (IT)

(72) Inventors: Paolo Di Trapani, Cavallasca (IT); Antonio Lotti, Arcisate (IT)

(21) Appl. No.: 19/485,625

(22) PCT Filed: May 16, 2024
(86) PCT No.: PCT/IB2024/054758

§ 371 Date: Nov. 18, 2025

(30) Foreign Application Priority Data
May 18, 2023 (IT) 102023000010107

(51) Int. Cl. F21S 13/14; F21V 7/22

(52) U.S. Cl. CPC F21S 13/14; F21V 7/22

(57) ABSTRACT

The present invention refers to a daylight management unit (200) comprising a light deflecting laminar element (210) comprising an inlet surface (211) and an outlet surface (212), the laminar element (210) comprising a first matrix (213) made of a first substantially non-absorbent host material at least with respect to electromagnetic radiation with a wavelength comprised in the visible light spectrum in which a plurality of reflecting elements (214) is incorporated, the plurality of reflecting elements (214) being arranged and configured, in the configuration of use, to deflect upward by reflection and direct toward the outlet surface (212) a light incident on the inlet surface (211) at a downward angle; and a chromatic diffuse light generator (220) configured to generate a diffuse light having a correlated color temperature (CCT) greater than or equal to 6,500 K or configured and arranged to produce a diffuse light having a correlated color temperature (CCT) greater than or equal to 6,500 K when illuminated by a collimated incident light having a correlated temperature of a colour higher than or equal to 5,500 K.

### TECHNICAL FIELD

The present invention refers in general terms to daylight management units for the interior or exterior coating of the transparent structures of a building façade, such as for example windows and glazing. In particular, the present invention relates to a chromatic effect daylight management unit, i.e. capable of interacting with an incident light coming from the outside of the buildings, in such a way as to generate internally a light with chromatic effects that offers to the observer a particular perception of the environment.

### STATE OF THE ART

Nowadays, the need for overall energy saving in the buildings is widespread. With specific reference to a reduction in energy consumption intended for indoor lighting of environments such as offices, homes and so on, solutions are known which are aimed at more efficient use of sunlight.

The transparent structures of a façade are aimed at delivering light to the indoor environments of the buildings such as rooms, corridors and the like. However, the angle at which natural sunlight hits on transparent structures is such that it does not penetrate deeply enough into the indoor environments. On the contrary, in the areas in proximity to the transparent structures, directly hit by the entering light, the lighting can be excessive and therefore unpleasant, resulting in shutters, blinds or curtains being closed, in this way, however, completely eliminating the source of natural lighting of the entire room. Furthermore, since sunlight enters in the windows at a downward angle, much of it is not useful for indoor lighting.

For these reasons, structures have been created that are capable of diffusing or redirecting the entering light rays upwards, so as to hit the ceiling, thus making the light effectively suitable for indoor lighting. Such structures, generally referred to as daylight management units, are usually positioned at the transparent structures of the façades of the buildings and configured to diffuse or deflect upwards a ray of light incident thereon at a downward angle. For example, these systems diffuse sunlight or deflect it towards the ceiling, usually white, which then assumes the role of a secondary source of substantially Lambertian diffuse light. An example of known daylight management units is described in U.S. Pat. No. 9,244,206.

The known daylight management units, while offering an excellent result in terms of redirecting incident sunlight, are usually not able to reproduce internally the lightening effect given by the sky, particularly perceptible as bluish coloring of the shadows. In fact, sunlight entering from a window provides a light/shadow effect similar to “black and white”, compared to what occurs outdoors, where the shadows are lit by the “sky” component, that is, the light component coming from the entire celestial vault, assuming an evidently bluish appearance. Internally to an environment, the “sky” component is cut from the window and only the portion that passes through the window opening contributes to illuminating the shadows. As a result, internally to the environments, the bluish coloring effect of the shadows is extremely reduced, the more it is reduced the more one moves aways from the window opening.

The Applicant has therefore strongly perceived the need to make a daylight management unit that is able to give a chromatic effect to the light that is emitted towards the indoor environment, recreating a lighting condition similar to that which would occur outdoors, that is, able to reproduce the bluish coloring effect of the shadows.

### SUMMARY OF THE INVENTION

In a first aspect, the present invention is directed to a daylight management unit which comprises a light deflecting laminar element comprising an inlet surface and an outlet surface, the laminar element comprising a first matrix made of a first substantially non-absorbent host material at least with respect to electromagnetic radiation with a wavelength comprised in the visible light spectrum in which a plurality of reflecting elements is incorporated, the plurality of reflecting elements being arranged and configured, in the configuration of use, to deflect upwards by reflection and direct towards the outlet surface a light incident on the inlet surface at a downward angle.

According to the present invention, the daylight management unit further comprises a chromatic diffuse light generator configured to generate a diffuse light having a correlated color temperature (CCT) greater than or equal to 6,500 K or configured and arranged to produce a diffuse light having a correlated color temperature (CCT) greater than or equal to 6,500 K when illuminated by a collimated incident light having a correlated color temperature higher than or equal to 5,500 K.

In the context of the present invention and the appended claims, collimated light is to be understood as, for example, a light having an angular profile of luminous intensity having a peak with width at half height (FWHM) of less than 1°, such as, for example, sunlight on a clear sky day.

Advantageously, the combined use of a chromatic diffuse light generator in association with a light deflecting laminar element at a transparent structure of the façade or roof of a building allows both to optimise the use of sunlight, by deflecting at least part of the sunlight incident on the window towards the ceiling, and to create internally to the environment delimited by the transparent structure the typical bluish appearance that the shadows assume outdoors.

In fact, the chromatic diffuse light generator generates within the environment, in an active or passive manner depending on the specific embodiment, a bluish diffuse light component in addition to that naturally transmitted by the transparent structure that otherwise alone would not be sufficient to produce natural lighting in the indoor environment.

Further features of the preferred embodiments of the daylight management unit for the interior or exterior coating of the transparent structures of a building façade according to the present invention are subject-matter of the dependent claims.

### BRIEF DESCRIPTION OF THE DRAWINGS

Further features and advantages of the present invention will become better apparent from the following detailed description of some preferred embodiments thereof, made with reference to the accompanying drawings, which are incorporated herein and constitute part of the description, illustrate exemplary embodiments of the present invention and, together with the description, are intended to illustrate the principles thereof. The different characteristics in the individual configurations presented in the detailed description can be combined with each other at will, in case the advantages resulting from a particular combination must be used specifically.

In the drawings:

FIG. 1 is a partial schematic view in side elevation of a daylight management unit according to a first embodiment of the present invention in the configuration of use, applied to a transparent structure of a building façade;

FIG. 1a is a perspective view of the daylight management unit of FIG. 1;

FIG. 2 is a partial schematic view in side elevation and in the configuration of use of a daylight management unit in accordance with a second embodiment of the present invention;

FIG. 3 is a partial schematic view in side elevation and in the configuration of use of a daylight management unit according to a third embodiment of the present invention;

FIG. 4 is a partial schematic view in side elevation and in the configuration of use of a daylight management unit according to a fourth embodiment of the present invention;

FIG. 5 is a partial schematic view in side elevation and in the configuration of use of a daylight management unit according to a fifth embodiment of the present invention;

FIG. 6 is a partial schematic view in side elevation and in the configuration of use of a daylight management unit according to a sixth embodiment of the present invention;

FIG. 7 is a partial schematic view in side elevation and in the configuration of use of a daylight management unit according to a seventh embodiment of the present invention;

FIG. 8 is a partial schematic view in side elevation and in the configuration of use of a daylight management unit according to an eighth embodiment of the present invention;

FIG. 8a is an enlarged detail of the light management unit of FIG. 8;

FIG. 8b is an enlarged detail of FIG. 8a;

FIG. 9 is a partial schematic view in side elevation and in the configuration of use of a daylight management unit according to an eighth embodiment of the present invention; and

FIG. 9a is an enlarged detail of the light management unit of FIG. 9.

### DETAILED DESCRIPTION

The following is a detailed description of exemplary embodiments of the present invention. The exemplary embodiments described herein and illustrated in the drawings are intended to convey the principles of the present invention, allowing the person skilled in the art to implement and use the present invention in numerous different situations and applications. Therefore, the exemplary embodiments are not intended, nor should they be considered, to limit the scope of patent protection. Rather, the scope of patent protection is defined by the accompanying claims.

For the illustration of the drawings, use is made in the following description of identical numerals or symbols to indicate construction elements with the same function. Moreover, for clarity of illustration, certain references may not be repeated in all drawings.

The use of “for example”, “etc.”, “or” indicates non-exclusive alternatives without limitation unless otherwise indicated. The use of “comprises” and “includes” means “comprises or includes, but not limited to”, unless otherwise indicated.

Furthermore, the use of measurements, values, shapes and geometric references (such as perpendicular and parallel) associated with terms such as “about”, “almost”, “substantially” or the like, is to be understood as “unless there are measurement errors” or “unless there are inaccuracies due to manufacturing tolerances” and in any case “unless there is a slight divergence with respect to the values, measurements, shapes or geometric references” to which the term is associated.

Finally, terms such as “first”, “second”, “upper”, “lower”, “main” and “secondary” are generally used to distinguish components belonging to the same type, not necessarily implying an order or priority of relationship or position.

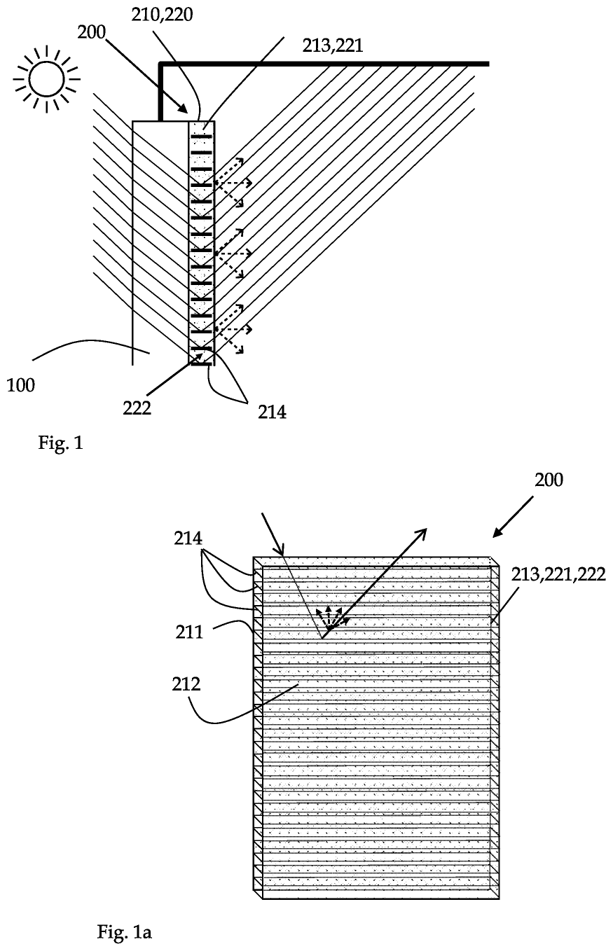

With reference to FIGS. 1 and 1a there is schematically illustrated a daylight management unit according to a first embodiment of the present invention—hereinafter for brevity's sake also simply ‘unit’—indicated overall with 200. In FIG. 1, the unit 200 is illustrated applied to a transparent structure of a building façade, specifically to a window 100.

The unit 200 of FIG. 1 comprises a light deflecting laminar element 210 comprising an inlet surface 211 and an outlet surface 212 (indicated in FIG. 1a). In particular, with reference to the configuration of use of the unit 200, the light deflecting laminar element 210 is configured to deflect upwards an incident light on its inlet surface 211 at a downward angle.

The laminar element 210 comprises a first matrix 213 made of a first substantially non-absorbent host material at least with respect to electromagnetic radiation with a wavelength comprised in the visible light spectrum (for example a resin with high transparency properties), in which a plurality of reflecting elements 214 is incorporated, such as for example a plurality of reflecting elements in which reflection can take place by total internal reflection or by regular reflection.

For example, the light deflecting laminar element 210 is a panel having a thickness greater than 1 mm, preferably greater than 2 mm, preferably greater than 3 mm, or it is a film or an adhesive having a micrometer thickness, i.e. a thickness less than 1 mm, preferably less than 0.5 mm, preferably less than 0.3 mm, and/or the reflecting elements of the plurality of reflecting elements 214 are micrometer elements.

Within the scope of the present description and in the appended claims by “micrometer element” is meant to indicate an element characterized by a sub-millimetre value for at least two dimensions among the three dimensions of length, width and thickness, for example having sub-millimetre width and thickness.

The reflecting elements 214 are arranged and configured in such a way that in the configuration of use they deflect upwards by reflection a light incident thereon at a downward angle, as shown in FIG. 1.

Within the scope of the present description and in the appended claims, by “to deflect upwards” is meant, in the configuration of use, the effect of reflection, possibly also multiple reflection, of at least part of the light rays incident on a reflecting element, along directions forming an angle greater than or equal to 0° with a horizontal plane (i.e. parallel to the ground) passing through the point of last reflection in the case of multiple reflections.

Within the scope of the present description and in the appended claims, by “configuration of use” it is intended to indicate a configuration that provides for a direction of incidence from above, for example at an angle of 30° degrees with respect to the horizontal plane, or preferably in the range between 25° and 40°, more preferably in the range between 20° and 50° with respect to the horizontal plane, like in the case of sunlight. For example, if the configuration of use is the typical configuration, that is, it provides that the light deflecting laminar element 210 is used with an outlet surface 212 parallel to a vertical plane, that is, in a pairing with a vertical window, by “upward deflection” is meant a deflection towards a direction forming an angle greater than or equal to 0° with respect to the normal to the outlet surface 212 and an angle less than or equal to 180° with respect to the direction of incidence. Alternatively, if the configuration of use provides for a non-zero angle of inclination α between the normal to the outlet surface 212 and the horizontal plane, i.e. it provides for pairing with a window or skylight having a normal inclination by a non-zero angle α with respect to the ground (like in the case of pairing with a skylight), by “upward deflection” is meant a deflection towards a direction forming an angle greater than or equal to the angle of inclination α with respect to the normal to the outlet surface 212. In this case the unit 200 will be characterized by the angle of inclination α.

In detail, the reflecting elements 214 are configured to regularly reflect an incident luminous flux comprising one or more electromagnetic radiations having wavelengths comprised at least in the visible spectrum (i.e., 380 nm≤λ≤740 nm).

In the embodiment of FIG. 1, the reflecting elements 214 are made as reflecting elements by total internal reflection. To this end, the first matrix 213 has a plurality of plate-shaped slits 214 that intersperse two contiguous portions of the first matrix 213, thereby defining reflection interfaces. Specifically in the embodiment of FIG. 1 the plate-like slits 214 are preferably all arranged parallel to each other, and preferably parallel to a horizontal plane, in the configuration of use. Further, the plate-like slits 214 are preferably evenly spaced from the contiguous slits. In this way, advantageously, the reflecting elements 214 are arranged and configured so as to substantially not obstruct and/or not distort the view of an image viewed through the laminar element 210 from a direction belonging to a horizontal plane.

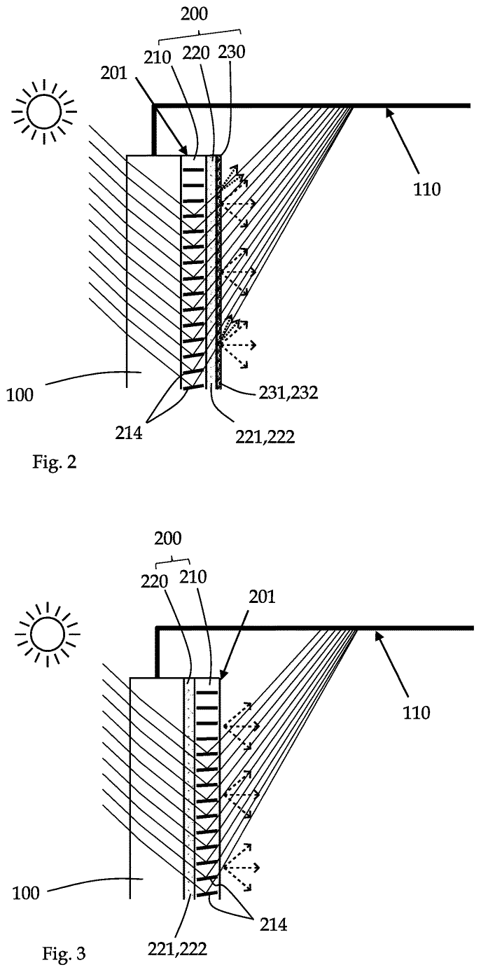

Conversely, in the embodiments of FIGS. 2 and 3, the plate-like slits 214 are made with an increasing inclination with respect to a horizontal plane, as the distance from an upper side 201 of the unit 200 increases, when in the configuration of use. In this way, in deflecting the incident light on the inlet surface 211, the rays are concentrated in a reduced area of the ceiling 110.

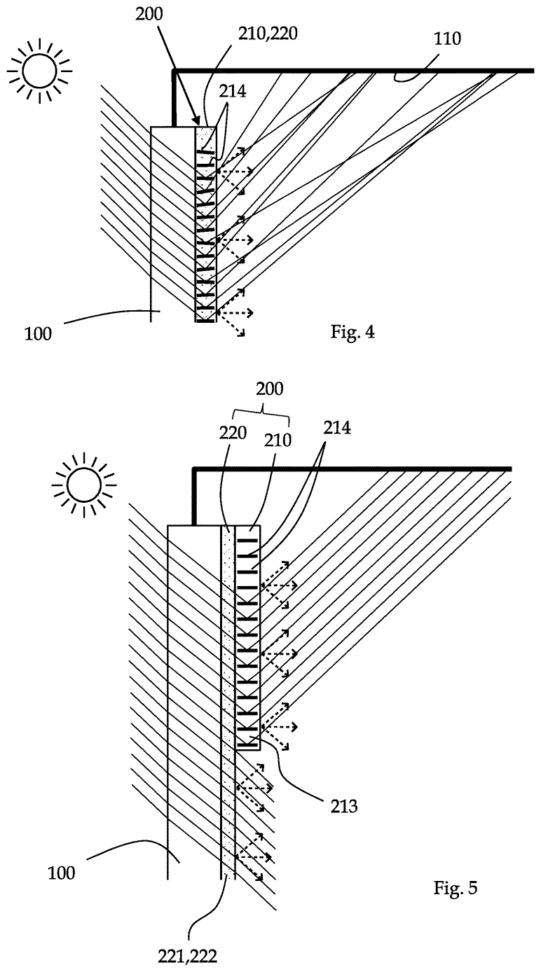

Still, in the embodiment of FIG. 4, the plate-like slits 214 are made with a random inclination with respect to the horizontal plane. In this way, in deflecting the incident light on the inlet surface 211, the rays are evenly distributed over a wider area of the ceiling 110, so as to increase the divergence of a light incident on its inlet surface 211 at a downward angle and which is then redirected upwards with greater divergence.

Advantageously, an increase in the divergence in the reflected or deflected light with respect to the divergence of the incident light increases the bluish coloring effect of the shadows further than what is produced by the chromatic diffuse light generator alone, so as to make the light in the indoor environment even more similar to the light of the exterior. In fact, this increase in divergence further reduces the illuminance value of the reflected light of the sun on the surfaces of the indoor environment, contributing to increasing the ratio between the illuminance of light blue light, diffused and of warm light, transmitted or reflected, further more than what can be achieved thanks to the effect alone of the chromatic diffuse light generator.

Equivalently, the reflecting elements 214 may be elements shaped like a plate comprising a reflective surface or face with a regular reflectance of at least 30%, preferably of at least 50%, more preferably of at least 70%. For example, they may be made of a metallic material, such as aluminium (Al), titanium (Ti), silver (Ag), zinc (Zn), etc. or an alloy, such as stainless steel, comprising such materials.

In an alternative embodiment not illustrated, the reflecting elements 214 are made curved in such a way as to increase the divergence of a light incident on its inlet surface 211 with an angle downwards and which is then redirected upwards with greater divergence.

The unit 200 of FIG. 1 further comprises a chromatic diffuse light generator 220 configured and arranged to produce a diffuse light having a correlated color temperature (CCT) greater than or equal to 6,500 K, preferably greater than or equal to 8,000 K, more preferably greater than or equal to 10,000K, even more preferably greater than or equal to 13,000 K. In the particular case illustrated in FIG. 1, the chromatic diffuse light generator 220 is configured and arranged to produce a diffuse light having CCT greater than or equal to 6,500 K when illuminated by a collimated incident light having a correlated color temperature higher than or equal to 5,500 K, such as for example sunlight. In other words, when illuminated by a collimated incident light having a correlated color temperature higher than or equal to 5,500 K, the chromatic diffuse light generator 220 employed in the unit 200 according to the invention ensures that a diffuse light having CCT greater than or equal to 6,500 K is generated.

For example, the chromatic diffuse light generator 220 is a film, a layer, or a panel or a coating having a greater regular transmittance for wavelengths of incident light comprised in the range of red than wavelengths of incident light comprised in the range of blue and a greater diffuse transmittance for wavelengths of incident light comprised in the range of blue than for wavelengths of incident light comprised in the range of red. In the context of this description and in the subsequent claims, the terms “regular transmittance” and “diffuse transmittance” refer to the definitions provided in the E284 standard relating to the terminology describing the appearance of materials and light sources (ASTM E284-09a, Standard Terminology of Appearance, ASTM International, West Conshohocken, PA, 2009). Furthermore, the term “spectral” refers to the regular transmittance and diffuse transmittance evaluated as a function of the wavelengths of light.

By “range of red” it is meant a range of wavelengths comprised between 600 nm and 740 nm.

By “range of yellow” it is meant a range of wavelengths comprised between 530 nm and 600 nm.

By “range of blue” it is meant in a broad sense a range of wavelengths comprised between 380 nm and 500 nm, thus also comprising the wavelengths that conventionally range from violet to cyan.

Consequently, when a light beam hits the chromatic diffuse light generator 220, the electromagnetic radiations with wavelengths comprised in the blue (380 nm≤λ≤500 nm) of the light beam preferentially undergo a diffusion—also referred to as scattering—with respect to the wavelengths comprised in the range of red (600 nm≤λ≤720 nm). For example, the chromatic diffuse light generator 220 substantially does not absorb light in the visible range and diffuses light at the wavelength of 450 nm (blue) at least 1.2 times, for example at least 1.4 times, as well as at least 1.6 times more efficiently than the light at the wavelength of about 630 nm (red). In other words, at a wavelength of 450 nm (blue) the diffuse transmittance of the chromatic diffuse light generator 220 is at least 1.2 times, for example at least 1.4 times, as well as at least 1.6 times greater than the diffuse transmittance at 630 nm (red). Similarly, the chromatic diffuse light generator 220 regularly transmits light at the wavelength of 630 nm (red) at least 1.05 times, for example at least 1.2 times, as well as at least 1.6 times, more efficiently than the light at a wavelength of about 450 nm (blue). In other words, at the wavelength of 630 nm (red) the regular transmittance of the chromatic diffuse light generator 220 is at least 1.05 times, for example at least 1.2 times, as well as at least 1.6 times greater than the regular transmittance at 450 nm (blue).

The film or layer or panel or coating 220 comprises, for example, a second matrix 221 made of a second substantially non-absorbent host material at least with respect to electromagnetic radiation with a wavelength comprised in the visible light spectrum (for example a resin with high transparency properties, such as PMMA or Polycarbonate) in which a plurality of nanometric diffusion elements 222 is dispersed, hereinafter for brevity's sake “nanoparticles”, of a material (organic, such as for example PMMA or Polystyrene or a fluorinated polymer, or inorganic, such as ZnO, TiO2, SiO2, Al2O3 and the like) that is substantially transparent or substantially non-absorbent at least with respect to electromagnetic radiation with a wavelength comprised in the visible light spectrum.

The nanoparticles may be monodisperse or polydisperse, may have a spherical shape or a different shape. In any case, the effective diameter d of the nanoparticles falls within the range [5 nm-350 nm], for example [10 nm-250 nm], or even [40 nm-180 nm], or [60 nm-150 nm]. In the context of the present invention and appended claims, by “effective diameter d of a particle” is meant the diameter of the equivalent spherical particle, i.e. of the spherical particle of the same material having diffusion properties more similar to those of the particle in question. Equivalently, by “effective diameter d of a particle” is meant the diameter of the smallest cylinder circumscribing it.

The refractive indices of the nanoparticles and of the second host material are different, and the index jump is such as to implement an incident light diffusion in a Rayleigh-like or chromatic diffusion regime. In particular, the nanoparticles have a first refractive index nₚ and are immersed in the second host material constituting the second matrix 221 that is substantially transparent or substantially non-absorbent at least with respect to electromagnetic radiation with a wavelength comprised in the visible light spectrum and having a second refractive index nₕ, such that a ratio between the refractive indices

$$m ≡ \frac{{n}_{p}}{{n}_{h}}$$

is comprised in the range 0.5≤m≤2.5, for example 0.7≤m≤2.1 or 0.7≤m≤1.9.

Considering that the diffusion effects are consequential, among other things, to the ratio of refractive indices between nanoparticles and the second host material, the nanoparticles may be both solid particles, and optically equivalent nanometric elements in liquid or gas phase, such as generally liquid or gas-phase inclusions (e.g., nano-droplets, nanovacuums, nano-inclusions, nanobubbles, etc.), i.e., elements that have nanometric sizes and are incorporated in the second host material.

In a particular configuration, the number N of nanoparticles acting as diffusers in the Rayleigh-like regime or in the chromatic diffusion regime, defined per unit area of the chromatic diffuse light generator 220 and as a function of an effective particle diameter D=d_{c} nₕ, preferably falls within the range defined by

$$N \geq {N}_{min} = \frac{3.47 \times {10}^{- 29}}{{D}^{6}} {\vert \frac{{m}^{2} + 2}{{m}^{2} - 1} \vert}^{2} [ {metres}^{- 2} ] , \\ ( D indicated in [ metres ] ) and N \leq {N}_{max} = \frac{2.03 \times {10}^{- 27}}{{D}^{6}} {\vert \frac{{m}^{2} + 2}{{m}^{2} - 1} \vert}^{2} [ {metres}^{- 2} ] .$$

For example, for embodiments that want to simulate the effect of a clear sky,

$$N \geq {N}_{min} = \frac{3.47 \times {10}^{- 29}}{{D}^{6}} {\vert \frac{{m}^{2} + 2}{{m}^{2} - 1} \vert}^{2} [ {metres}^{- 2} ] , \\ ( D indicated in [ metres ] ) and N \leq {N}_{max} = \frac{4.05 \times {10}^{- 28}}{{D}^{6}} {\vert \frac{{m}^{2} + 2}{{m}^{2} - 1} \vert}^{2} [ {metre}^{- 2} ] ,$$

such as for example

$$N \geq {N}_{min} = \frac{5.65 \times {10}^{- 29}}{{D}^{6}} {\vert \frac{{m}^{2} + 2}{{m}^{2} - 1} \vert}^{2} [ {metres}^{- 2} ] and N \leq {N}_{max} = \frac{3.46 \times {10}^{- 28}}{{D}^{6}} {\vert \frac{{m}^{2} + 2}{{m}^{2} - 1} \vert}^{2} [ {metres}^{- 2} ] ,$$

more specifically

$$N \geq {N}_{min} = \frac{7.13 \times {10}^{- 29}}{{D}^{6}} {\vert \frac{{m}^{2} + 2}{{m}^{2} - 1} \vert}^{2} [ {metres}^{- 2} ] e N \leq {N}_{max} = \frac{3.13 \times {10}^{- 28}}{{D}^{6}} {\vert \frac{{m}^{2} + 2}{{m}^{2} - 1} \vert}^{2} [ {metres}^{- 2} ] .$$

Otherwise, for embodiments that want to simulate the effect of a Nordic sky,

$$N \geq {N}_{min} = \frac{4.05 \times {10}^{- 28}}{{D}^{6}} {\vert \frac{{m}^{2} + 2}{{m}^{2} - 1} \vert}^{2} [ {metres}^{- 2} ] , \\ ( D indicated in [ metres ] ) and N \leq {N}_{max} = \frac{2.03 \times {10}^{- 27}}{{D}^{6}} {\vert \frac{{m}^{2} + 2}{{m}^{2} - 1} \vert}^{2} [ {metres}^{- 2} ] ,$$

such as for example

$$N \geq {N}_{min} = \frac{4.05 \times {10}^{- 28}}{{D}^{6}} {\vert \frac{{m}^{2} + 2}{{m}^{2} - 1} \vert}^{2} [ {metres}^{- 2} ] and N \leq {N}_{max} = \frac{7.71 \times {10}^{- 28}}{{D}^{6}} {\vert \frac{{m}^{2} + 2}{{m}^{2} - 1} \vert}^{2} [ {metres}^{- 2} ] ,$$

more specifically

$$N \geq {N}_{min} = \frac{4.05 \times {10}^{- 28}}{{D}^{6}} {\vert \frac{{m}^{2} + 2}{{m}^{2} - 1} \vert}^{2} [ {metres}^{- 2} ] and N \leq {N}_{max} = \frac{6.37 \times {10}^{- 28}}{{D}^{6}} {\vert \frac{{m}^{2} + 2}{{m}^{2} - 1} \vert}^{2} [ {metres}^{- 2} ] .$$

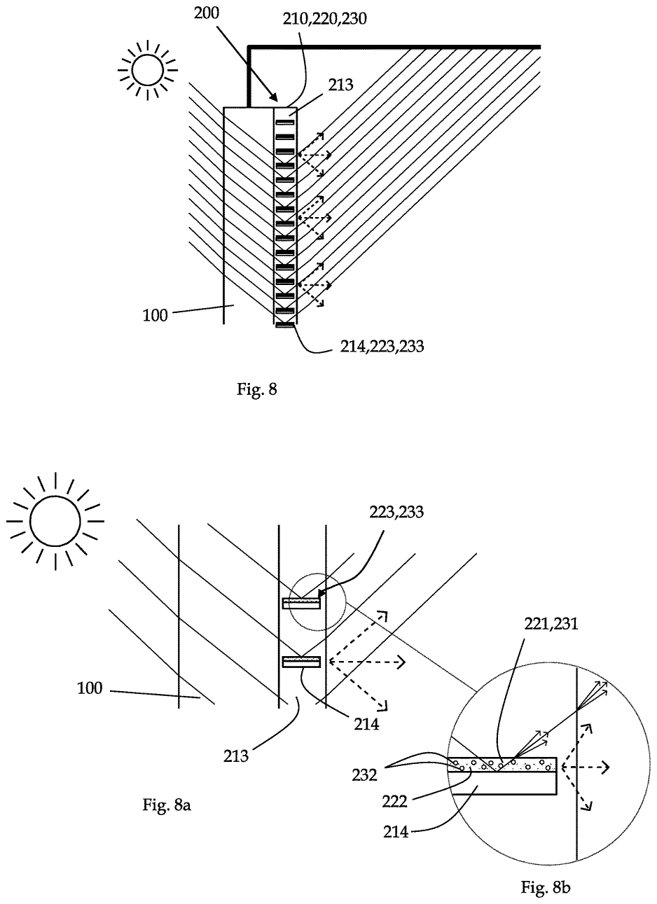

In the event that the film or layer or panel or coating 220 is employed in a configuration such that incident light traverses it in a double pass, as in the embodiment described below with reference to FIG. 8, the extreme values of the ranges of the number N of nanoparticles indicated above are to be considered halved.

In the embodiment of FIG. 1, the chromatic diffuse light generator 220 is incorporated in the laminar element 210. In such a configuration, the first 213 and second 221 matrices coincide, i.e. the first and second host material are the same material, and the nanoparticles 222 are incorporated in the same matrix 213,221 in which the reflecting elements 214 of the laminar element 210 are incorporated.

Conversely, in the embodiment of FIG. 2, the chromatic diffuse light generator 220 is made like a film or layer that adheres to the outlet surface 212 of the laminar element 210.

In a different embodiment (not illustrated), the chromatic diffuse light generator 220 is made like a panel that adheres or is hooked or is placed side by side with the outlet surface 212 of the laminar element 210.

According to a still different embodiment illustrated in FIG. 3, the chromatic diffuse light generator 220 is made like a coating of the inlet surface 211 of the laminar element 210.

According to a further embodiment (not illustrated), the chromatic diffuse light generator 220 is made like a film or layer or coating or panel applied to or placed side by side with both the inlet surface 211 and the outlet surface 212 of the laminar element 210.

In general terms, the chromatic diffuse light generator 220 and the laminar element 210 can be two distinct elements arranged side by side, but spatially separated, or constitute a single element in which the chromatic diffuse light generator 220 is arranged in a manner adjacent to and/or in contact with and/or glued to the inlet surface 211 or to the outlet surface 212 of the laminar element 210. In addition, the laminar element 210 can have the same vertical extension with respect to the chromatic diffuse light generator 220 with reference to the configuration of use such as for example shown in FIGS. 1-4, or a lower vertical extension than the chromatic diffuse light generator 220 with reference to the configuration of use, as shown in FIG. 5.

The unit 200 of FIG. 2 further comprises an achromatic scattered light generator 230 configured to increase the divergence of a light passing therethrough in a manner substantially independent of the wavelength. The achromatic scattered light generator 230 causes an increase in divergence of a light that is redirected upwards by the reflecting elements 214 with respect to the incident light on the inlet surface 211 at a downward angle.

Preferably, the achromatic scattered light generator 230 comprises a third matrix 231 made of a third substantially non-absorbent host material at least with respect to electromagnetic radiation with a wavelength comprised in the visible light spectrum (for example a polymeric matrix) in which a plurality of micrometer diffusion elements 232 is dispersed, hereinafter for brevity's sake “microparticles”, of at least one substantially transparent or substantially non-absorbent material at least with respect to electromagnetic radiation with a wavelength comprised in the visible light spectrum. The third host material has a refractive index different from the refractive index of the at least one material comprised in the microparticles 231, for example different by at least 2%, preferably at least 5%, more preferably by at least 10%.

The microparticles 231 for example have an average effective diameter comprised in the range between 0.5 and 100 microns, preferably between 1 and 50 microns, and/or are spherical microparticles made of a polymeric or glassy material, for example they are hollow microspheres (such as for example gas phase microinclusions, microvacuums, microbubbles, etc.).

In the embodiment of FIG. 2, the achromatic scattered light generator 230 is a layer of achromatic diffusive material made like a film or paint that at least partially covers a surface of the chromatic diffuse light generator 220. In a completely equivalent manner, the achromatic scattered light generator 230 can be made like a panel, film or coating. Furthermore, it can adhere, be hooked or placed side by side with the inlet 211 and/or outlet 212 surface of the laminar element 210.

According to yet another variant of the present invention (not illustrated), the achromatic scattered light generator 230 is incorporated in the chromatic diffuse light generator 220. In such a variant the second matrix 211 of the chromatic diffuse light generator 220 additionally comprises a dispersion of microparticles 231 having a refractive index different from the refractive index of the second host material constituting the second matrix 221.

In a still further variant of the present invention (not illustrated), the chromatic diffuse light generator 220 and the achromatic scattered light generator 230 are incorporated in the laminar element 210. In such a configuration, the first 213, the second 221 and the third 231 matrix coincide, i.e. the first, the second and the third host material are the same material, and the nanoparticles 222 and the microparticles 232 are incorporated in the same matrix 213,221,232 in which the reflecting elements 214 of the laminar element 210 are incorporated.

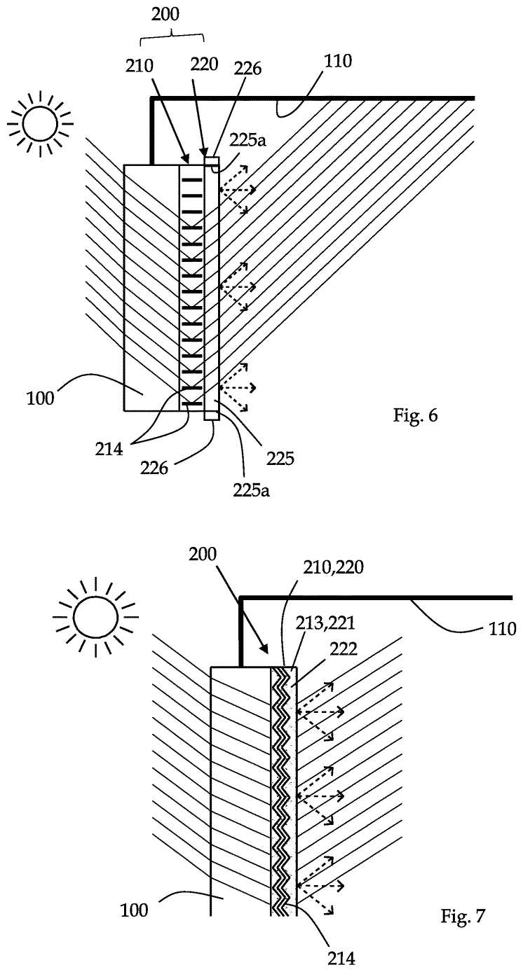

In a different embodiment illustrated in FIG. 6, the chromatic diffuse light generator 220 is an artificial light source comprising a diffuser panel 225 illuminated by a plurality of light sources 226, such as an LED source, coupled to an edge 225a of the diffuser panel and emitting a light with a correlated color temperature greater than or equal to 8,000 K, 10,000 K, or 13,000 K.

In another embodiment illustrated in FIG. 7, the reflecting elements 214 are made like microprisms embedded in the first matrix 213 and made of a material having a refractive index different from a refractive index of the material in which the first matrix 213 is made.

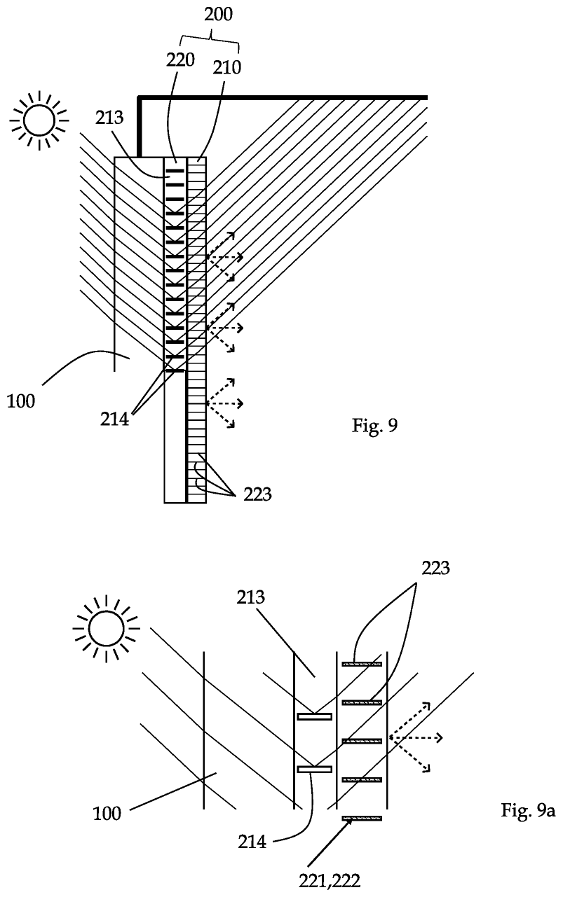

In another preferred embodiment of the present invention, a first variant of which is illustrated in FIG. 8 and a second variant is shown in FIG. 9, the chromatic diffuse light generator 220 of the unit 200 comprises a plurality of layers of chromatic diffusive material 223, arranged spaced apart from each other, and preferably according to an arrangement parallel to a horizontal plane in such a way as to reduce the impact section or visibility thereof when viewed edge-on.

Each layer of chromatic diffusive material 223 has an elongated development along a respective development axis of the layer. In particular, the layers of chromatic diffusive material 223 have a substantially constant section orthogonal to the development axis having a barycentre and the set of barycentres of the sections of a layer 223 defines a barycentre axis of said layer 223. The layers of chromatic diffusive material 223 are arranged parallel to each other, such that their barycentre axes are all comprised in a same plane of the barycentre axes, and spaced apart along a direction comprised in the plane of the barycentre axes and orthogonal to such barycentre axes. In particular, each layer of chromatic diffusive material 223 is spaced from the contiguous layer by a non-zero distance, measured in the plane of the barycentre axes as the distance between the respective barycentre axes. With the unit installed for use, the layers of chromatic diffusive material 223 are supported with the set of their barycentre axes comprised in a vertical plane; the direction along which the layers of chromatic diffusive material 223 are spaced from each other is, specifically, the vertical direction (i.e. perpendicular to the ground). Preferably, the thickness of the layers of chromatic diffusive material 223 is much less than the distance between the layers, for example less than ⅓, preferably 1/10, more preferably 1/30 of the distance between the layers.

Each layer of chromatic diffusive material 223 comprises the second matrix 221 in which there is dispersed the plurality of nanoparticles 222 which are configured in such a way as to implement a diffusion of incident light in a Rayleigh-like or chromatic diffusion regime, as described in detail above with reference to the embodiments of FIGS. 1-5 and 7.

As shown in detail in FIG. 8a, in the variant of FIG. 8 the layers of chromatic diffusive material 223 are embedded in the first matrix 213 each at a respective reflecting element 214, in particular according to an arrangement adjacent to and/or parallel to a reflective surface of each reflecting element 214. For example, the layers of chromatic diffusive material 223 are a paint covering or partially covering the reflecting elements 214. Preferably, the layers of chromatic diffusive material 223 are embedded in the first matrix 213 according to an arrangement parallel to a horizontal plane with reference to the configuration of use of the unit 200.

In the embodiment of FIG. 8, the achromatic scattered light generator 230 comprises a plurality of substantially planar layers of achromatic diffusive material 233, arranged spaced apart from each other preferably according to an arrangement parallel to a horizontal plane and configured to increase divergence of a light passing therethrough in a manner substantially independent of the wavelength. Preferably, the thickness of the layers of achromatic diffusive material 233 is much less than the distance between the layers 233, for example less than ⅓, preferably 1/10, more preferably 1/30 of the distance between the layers 233.

Advantageously, unlike the case in which the achromatic scattered light generator 230 comprises a film or layer parallel to a vertical plane, for example arranged on the inlet 211 or outlet 212 surface of the laminar element 210, the configuration of FIG. 8 comprises a plurality of layers of achromatic diffusive material 233 arranged substantially parallel to the horizontal plane in such a way as to reduce the impact section or visibility thereof when viewed edge-on, i.e. when the observer looks through the unit 200 from a direction lying on a horizontal plane.

In the configuration of FIG. 8, each layer of achromatic diffusive material 233 is a film or a paint that at least partially covers a reflecting element 214. Preferably, the layers of achromatic diffusive material 233 and the reflecting elements 214 are configured and arranged in such a way that a light incident on the inlet surface 211 of the laminar element 210 at a downward angle that is reflected by a reflecting element 214, passes in a double pass through a layer of achromatic diffusive material 233, exiting from the outlet surface 212 of the laminar element 210 with a divergence greater than 10°, preferably greater than 20°, more preferably greater than 30° in case the incident light has divergence of less than 1°.

As illustrated in FIG. 8b, each layer of achromatic diffusive material 233 is incorporated in a layer of chromatic diffusive material 223. To this end, the layers of chromatic diffusive material 223 additionally comprise a dispersion of microparticles configured and arranged so as to confer to each layer of chromatic diffusive material 223 also the property of diffusing at low angle the incident light in a manner substantially independent of the wavelength. In other words, in this preferred configuration the layers of chromatic diffusive material 223 and the layers of achromatic diffusive material 233 coincide, both the microparticles and the nanoparticles being dispersed in the same matrix. Preferably the layers of chromatic diffusive material 223 also comprising a dispersion of microparticles are a paint or a coating covering the reflective layers 214.

A method for making a unit 200 as illustrated in FIG. 8 233 comprises the steps consisting of:
(i) making the reflecting elements 214 by coupling two sheets of a transparent material, the first characterized by the presence of linear elements extruded or emerging from the surface of the sheet and the second by the presence of linear elements intruded or hollowed out in the surface of the sheet, for example linear elements with a rectangular or trapezoidal or triangular section, these linear elements being configured and arranged in such a way that the coupling between the two sheets leaves interspaces or slits in use substantially conforming to horizontal plates 214, and
(ii), before coupling the two sheets, painting at least the upper face of the linear elements intruded or hollowed out in the second sheet which face, in use, turns out to be the upper face of the slit or plate 214 substantially parallel to a horizontal plane.
wherein the painting is carried out by means of a paint comprising a first dispersion of nanoparticles and/or a second dispersion of microparticles such that, once dried, it entails the formation of a layer of chromatic diffusive material 223 and/or of a layer of achromatic diffusive material 233 that are substantially planar and/or forming a single layer, and in such a way that, in use, the lower surface of said layer of chromatic diffusive material 223 and/or of said layer of achromatic diffusive material 233 and/or of the layer resulting from the combination of both turns out to be the upper interface surface of the slit or plate 214, i.e. the reflective surface of the reflecting element 214 that reflects the light incident from above on the inlet surface 111 of the laminar element 210 by total internal reflection (TIR).

In the variant of FIG. 9, the layers of chromatic diffusive material 223 are external to the laminar element 210 and placed in proximity to the same 210, for example at the relative inlet surface 211 or, as shown in FIG. 9a, of the relative outlet surface 212. Each layer of chromatic diffusive material 223 is for example shaped like a substantially planar plate or plate curved in a plane orthogonal to the barycentre axis. Although not illustrated, in this variant the layers of chromatic diffusive material 223 are constrained to a support structure that maintains them according to the superimposed arrangement, with the barycentre axes parallel to a horizontal plane and mutually spaced along a vertical direction.

Preferably, the layers of chromatic diffusive material 223 are constrained to the support structure in such a way as to be able to rotate each around an axis of rotation parallel or coinciding with the respective barycentre axis, being able to assume a substantially parallel or inclined configuration with respect to the ground. For example, the support structure may be of the rigid type or comprise a plurality of suspension ties connected to an upper support bar. The suspension ties are tied to the layers of diffusive material in a known manner, in such a way as to be able to control them all simultaneously in rotation, each around its own development axis. Furthermore, the suspension ties are tied to the layers of diffusive material in such a way as to allow a lifting of the layers of diffusive material towards each other until reaching a condition of maximum lift and/or close-packing of the layers of chromatic diffusive material 223.

The operation of the daylight management unit according to the present invention is as follows. A light incident on the inlet surface 211 of the light deflecting laminar element 210 at a downward angle is redirected by the reflecting elements 214 towards the ceiling where it is diffused by the ceiling itself, reproducing a secondary light source. In this way, the overall lighting of the indoor environment is increased and, in the same way, the lighting is reduced in the area in proximity to the transparent structures, so that it is no longer excessive and unpleasant.

In addition, thanks to the use of the chromatic diffuse light generator 220, it is possible to recreate, internally to the environment delimited by the transparent structure of a building façade to which the unit is applied, the typical bluish appearance assumed by the shadows outdoors, because of the illumination due to the light component coming from the entire celestial vault.

In fact, the chromatic diffuse light generator 220 actively or passively generates within the environment, the component of bluish diffuse light that otherwise would not be able to penetrate through the window.

In particular, the chromatic diffuse light generator 220 can extend as far as the light deflecting laminar element 210 extends or have a greater extension. In fact, in general, the light deflecting laminar element 210 is placed at the top of windows and glazing as the reflecting elements 214, in certain configurations, can distort the view of the external environment.

In case the chromatic diffuse light generator 220 comprises a plurality of layers of chromatic diffusive material 223 arranged according to an arrangement parallel to a horizontal plane, it happens that when looking outside the transparent structure, the view of the exterior is substantially unobstructed. This advantage derives from the particular positioning of the layers of chromatic diffusive material 223 that have only a reduced impact section when viewed “edge-on”. At the same time, such layers 223, when hit by direct white light, generate diffuse blue light internally to the environment. In such a configuration, one advantageously has a chromatic diffuse light generator 220 with extension higher than the light deflecting laminar element 210 in such a way that the latter is superimposed only on a high part of the transparent structure (usually in a portion higher than the portion that falls within the visual field of the users), while the chromatic diffuse light generator 220 can be superimposed on the entire surface of the transparent structure, therefore also on the portion of structure that corresponds to the visual field of the users. In fact, its structure, which essentially does not hinder the view of the exterior, makes it possible to position it also at the users' viewing area. Advantageously, the extension of the chromatic diffuse light generator 220 along the entire transparent structure allows to have a chromatic uniformity of the entering light that in the part where it interacts with the chromatic diffuse light generator 220 turns out to have a lower CCT, compared to the light that penetrates the environment in the absence of interaction.

1. Daylight management unit (200) comprising
a light deflecting laminar element (210) comprising an inlet surface (211) and an outlet surface (212), the laminar element (210) comprising a first matrix (213) made of a first substantially non-absorbent host material at least with respect to electromagnetic radiation with a wavelength comprised in the visible light spectrum in which a plurality of reflecting elements (214) is incorporated, the plurality of reflecting elements (214) being arranged and configured, in the configuration of use, to deflect upwards by reflection and direct towards the outlet surface (212) a light incident on the inlet surface (211) at a downward angle; and
a chromatic diffuse light generator (220), wherein the chromatic diffuse light generator (220) is an artificial light source comprising a diffuser panel (225) illuminated by a plurality of light sources (226) emitting a diffuse light having a correlated color temperature (CCT) greater than or equal to 6,500 K.

2. Daylight management unit (200) according to claim 1,
wherein the plurality of light sources (226) is configured to emit a diffuse light having a correlated color temperature (CCT) greater than or equal to 8,000 K, preferably greater than or equal to 10,000 K, more preferably greater than or equal to 13,000 K.

3. Daylight management unit (200) according to claim 1 or 2,
wherein the plurality of light sources (226) is coupled to an edge (225a) of the diffuser panel.

4. Daylight management unit (200) according to any one of the preceding claims,
wherein the diffuser panel (225) is placed adjacent to or in contact with the inlet surface (211) and/or with the outlet surface (212) of the light deflecting laminar element (210).

5. Daylight management unit (200) according to claim 4,
wherein the diffuser panel (225) covers the entire inlet surface (211) and/or the entire outlet surface (212) of the laminar element (210).

6. Daylight management unit (200) according to any one of the preceding claims, comprising an achromatic scattered light generator (230) configured to increase the divergence of a light incident on its inlet surface (211) at a downward angle and which is redirected upwards in a manner substantially independent of the wavelength of the incident light,
wherein, preferably, the achromatic scattered light generator (230) comprises a plurality of substantially planar layers of achromatic diffusive material (233), arranged spaced apart from each other along a vertical direction and preferably according to an arrangement parallel to a horizontal plane.

7. Daylight management unit (200) according to any one of the preceding claims,
wherein the reflecting elements (214) of the plurality of micrometer reflecting elements (214) are arranged and configured to substantially not obstruct or not distort the view of an image viewed through the laminar element (210) from a direction belonging to a horizontal plane, each reflecting element (214) of the plurality of reflecting elements (214) preferably defining at least one reflective surface parallel to a horizontal plane.

8. Daylight management unit (200) comprising
a light deflecting laminar element (210) comprising an inlet surface (211) and an outlet surface (212), the laminar element (210) comprising a first matrix (213) made of a first substantially non-absorbent host material at least with respect to electromagnetic radiation with a wavelength comprised in the visible light spectrum in which a plurality of reflecting elements (214) is incorporated, the plurality of reflecting elements (214) being arranged and configured, in the configuration of use, to deflect upwards by reflection and direct towards the outlet surface (212) a light incident on the inlet surface (211) at a downward angle;
a chromatic diffuse light generator (220) configured and arranged to produce a diffuse light having a correlated color temperature (CCT) greater than or equal to 6,500 K when illuminated by a collimated incident light having a correlated color temperature higher than or equal to 5,500 K; and
wherein the chromatic diffuse light generator (220) comprises a second matrix (221) made of a second substantially non-absorbent host material at least with respect to electromagnetic radiation with a wavelength comprised in the visible light spectrum and having a host material refractive index (nₕ), in the second matrix (221) there being dispersed a plurality of nanometric diffusion elements (222) made of a substantially transparent or substantially non-absorbent material at least with respect to electromagnetic radiation with a wavelength comprised in the visible light spectrum and having a particle refractive index (nₚ), different from the host material refractive index (nₕ), wherein a ratio (m≡nₚ/nₕ) between the particle refractive index (nₚ) and the host material refractive index (nₕ), a number (N) of nanometric elements per unit area and an average nanometric element size of the plurality of nanometric scattering elements referred to a diameter of an equivalent spherical particle and/or to a diameter of the smallest cylinder circumscribing them are selected to preferentially diffuse components of incident light at a small wavelength with respect to components of incident light at a large wavelength and to preferentially transmit components of incident light at a large wavelength with respect to components of incident light at a small wavelength; and/or
wherein the chromatic diffuse light generator (220) is a layer of material having a greater regular transmittance for wavelengths of incident light comprised in the range of red than wavelengths of incident light comprised in the range of blue and a greater diffuse transmittance for wavelengths of incident light comprised in the range of blue than for wavelengths of incident light comprised in the range of red.

9. Daylight management unit (200) according to claim 8,
wherein the chromatic diffuse light generator (220) is configured and arranged to produce a diffuse light having a correlated color temperature (CCT) greater than or equal to 8,000 K, preferably greater than or equal to 10,000 K, more preferably greater than or equal to 13,000 K.

10. Daylight management unit (200) according to claim 8 or 9,
wherein the second matrix (221) of the chromatic diffuse light generator (220) coincides with the first matrix (213) of the light deflecting laminar element (210), the chromatic diffuse light generator (220) being incorporated in the light deflecting laminar element (210); or
wherein the chromatic diffuse light generator (220) is a film or a layer or a panel or a coating placed adjacent to or in contact with the inlet surface (211) and/or with the outlet surface (212) of the light deflecting laminar element (210), the film or the panel or the coating preferably covering the entire inlet surface (211) and/or the entire outlet surface (212) of the laminar element (210).

11. Daylight management unit (200) according to claim 8 or 9,
wherein the chromatic diffuse light generator (220) comprises a plurality of layers of chromatic diffusive material (223) each comprising the second matrix (221) in which the plurality of nanometric scattering elements (222) is dispersed, the layers of chromatic diffusive material (223) being arranged spaced apart from each other along a vertical direction and preferably according to an arrangement parallel to a horizontal plane.

12. Daylight management unit (200) according to claim 11,
wherein the plurality of layers of chromatic diffusive material (223) is embedded in the first matrix (213) of the light deflecting laminar element (210), each layer of chromatic diffusive material (223) of the plurality of layers of chromatic diffusive material (223) being arranged at a respective reflecting element (214), preferably according to an arrangement adjacent to and/or parallel to a reflective surface of each reflecting element (214).

13. Daylight management unit (200) according to claim 11,
wherein the plurality of layers of chromatic diffusive material (223) are arranged externally and in proximity to the laminar element (210), at the inlet surface (211) and/or at the outlet surface (212), and wherein, preferably, each layer of chromatic diffusive material (223) of the plurality of layers of chromatic diffusive material (223) has an elongated development along a respective development axis of the layer, and is shaped like a substantially planar plate or plate curved in a plane orthogonal to the development axis.

14. Daylight management unit (200) according to claim 13,
wherein each layer of chromatic diffusive material (223) of the plurality of layers of chromatic diffusive material (223) is rotatable around an axis of rotation parallel or coinciding with a respective development axis, being able to assume a substantially parallel or inclined configuration with respect to a horizontal plane; and/or
wherein each layer of chromatic diffusive material (223) of the plurality of layers of chromatic diffusive material (223) is movable towards and away from an upper layer of chromatic diffusive material (223) between a configuration of maximum lift and/or close-packing of the layers of chromatic diffusive material (223) and a configuration of maximum distancing from contiguous layers of chromatic diffusive material (223).

15. Daylight management unit (200) according to any one of claims 8 to 14, comprising an achromatic scattered light generator (230) configured to increase the divergence of a light incident on its inlet surface (211) at a downward angle and which is redirected upwards in a manner substantially independent of the wavelength of the incident light,
wherein, preferably, the one achromatic scattered light generator (230) comprises a plurality of substantially planar layers of achromatic diffusive material (233), arranged spaced apart from each other along a vertical direction and preferably according to an arrangement parallel to a horizontal plane.

16. Daylight management unit (200) according to any one of claims 8 to 15,
wherein the reflecting elements (214) of the plurality of micrometer reflecting elements (214) are arranged and configured to substantially not obstruct or not distort the view of an image viewed through the laminar element (210) from a direction belonging to a horizontal plane, each reflecting element (214) of the plurality of reflecting elements (214) preferably defining at least one reflective surface parallel to a horizontal plane.

17. Daylight management unit (200) comprising
a light deflecting laminar element (210) comprising an inlet surface (211) and an outlet surface (212), the laminar element (210) comprising a first matrix (213) made of a first substantially non-absorbent host material at least with respect to electromagnetic radiation with a wavelength comprised in the visible light spectrum in which a plurality of reflecting elements (214) is incorporated, the plurality of reflecting elements (214) being arranged and configured, in the configuration of use, to deflect upwards by reflection and direct towards the outlet surface (212) a light incident on the inlet surface (211) at a downward angle;
a chromatic diffuse light generator (220) configured to generate a diffuse light having a correlated color temperature (CCT) greater than or equal to 6,500 K or configured and arranged to produce a diffuse light having a correlated color temperature (CCT) greater than or equal to 6,500 K when illuminated by a collimated incident light having a correlated color temperature higher than or equal to 5,500 K; and
an achromatic scattered light generator (230) configured to increase the divergence of a light incident on its inlet surface (211) at a downward angle and which is redirected upwards in a manner substantially independent of the wavelength of the incident light.

18. Daylight management unit (200) according to claim 17,
wherein the chromatic diffuse light generator (220) is configured to generate a diffuse light having a correlated color temperature (CCT) greater than or equal to 8,000 K, preferably greater than or equal to 10,000 K, more preferably greater than or equal to 13,000 K, or wherein the chromatic diffuse light generator (220) is configured and arranged to produce a diffuse light having a correlated color temperature (CCT) greater than or equal to 8,000 K, preferably greater than or equal to 10,000 K, more preferably greater than or equal to 13,000 K.

19. Daylight management unit (200) according to claim 17 or 18,
wherein the chromatic diffuse light generator (220) has a greater regular transmittance for wavelengths of incident light comprised in the range of red than wavelengths of incident light comprised in the range of blue and a greater diffuse transmittance for wavelengths of incident light comprised in the range of blue than for wavelengths of incident light comprised in the range of red.

20. Daylight management unit (200) according to any one of claims 17 to 19,
wherein the achromatic scattered light generator (230) comprises a plurality of substantially planar layers of achromatic diffusive material (233), arranged spaced apart from each other along a vertical direction and preferably according to an arrangement parallel to a horizontal plane.

21. Daylight management unit (200) according to any one of claims 17 to 20,
wherein the reflecting elements (214) of the plurality of micrometer reflecting elements (214) are arranged and configured to substantially not obstruct or not distort the view of an image viewed through the laminar element (210) from a direction belonging to a horizontal plane, each reflecting element (214) of the plurality of reflecting elements (214) preferably defining at least one reflective surface parallel to a horizontal plane.
